(19) United States
(12) Patent Application Publication
(10) Pub. No.: US 2007/0263974 A1
(43) Pub. Date: Nov. 15, 2007

(54) Laser Inscription of Optical Structures in Crystals

(76) Inventors: Igor Khrushchev, Birmingham (GB); Andrei Okhrimchuck, Moscow (RU)

Correspondence Address: DUNLAP CODDING & ROGERS, P.C., PO BOX 16370, OKLAHOMA CITY, OK, 73113, US

(21) Appl. No.: 10/575,675

(22) PCT Filed: Oct. 11, 2004
(86) PCT No.: PCT/GB04/04334

§ 371 Date: Mar. 16, 2007

(30) Foreign Application Priority Data
Oct. 11, 2003 (GB) 0323922.5

(51) Int. Cl. G02B 6/12

(52) U.S. Cl. 385/141

(57) ABSTRACT

A method of altering the refractive index of a region of a crystal comprising focusing a pulsed laser beam at a desired position within the crystal and moving the focused beam along a path such that the focussed beam alters the refractive index of the region of the crystal along the path.

### CROSS-REFERENCE TO RELATED APPLICATIONS

The present patent application claims benefit under 35 U.S.C. 371(c) of PCT International Patent Application No. PCT/GB2004/004334, filed Oct. 11, 2004, entitled “LASER INSCRIPTION OF OPTICAL STRUCTURES IN CRYSTALS”, which in turn, claims priority to the patent application filed on Oct. 11, 2003 and identified by GB Serial No. 0323922.5. The entire contents of both of which are hereby incorporated by reference in their entirety as if set forth explicitly herein.

This invention relates to methods of altering the refractive index of portions of and inscribing optical structures in, materials such as crystals by laser irradiation, and to laser inscribed crystals, particularly but not exclusively, laser crystals.

It is known to attempt to form waveguides within crystal media. Providing waveguides within crystals has multiple applications but is particularly useful in laser crystals for solid state lasers. Common problems with some laser crystals such as Ti:Al₂O₃, and Cr doped Yttrium Aluminum Garnet (YAG), are a relatively low optical gain and ineffective pumping of the crystal. Consequently it is difficult to design a laser cavity with such crystals, capable of effective light pumping and having low loss of a signal wavelength. It is much easier to obtain this combination of features with a laser cavity having waveguides on or in the laser crystals rather than using surrounding bulk optics.

Formation of waveguides in laser crystal media is conventionally difficult. One current method is to build an epitaxial layer on top of a crystal of different refractive index to the crystal which will form a waveguide at the interface. An alternative method is to attempt to create a region of differing refractive index near the surface of a laser crystal by diffusion. Due to these methods of fabrication the waveguide is necessarily at or near the surface of the crystal and not deeply embedded or within the bulk of the crystal.

All of the conventional methods involve processing in a vacuum adding to cost, deliver limited quality waveguides and are restricted geometrically as the waveguide can only be formed at the crystal surface or close very close to the surface. Waveguides created by such methods are typically within 10 μm of the surface of the crystal.

It is also known to inscribe optical structures such as waveguides into some glasses such as borosilicate glass, as described in US Patent application 2002/0076655 Al. In this process a femtosecond pulse laser is used to increase the refractive index of the glass at a focal point and this point is translated in order to form optical structures. Using such specialist techniques like those disclosed in US 2002/0076655 it is possible to create these optical structures without causing breakdown damage of the glass. These inscribed pieces of glass have for example been suggested for use in fibre optic technologies where the need to guide light by using different refractive indeces of glass is common. Whilst the detailed physics explaining why and how the refractive index is changed by the focused laser is not fully understood at present, it is known to effect different materials differently.

Present experience and understanding of the physics suggest that such laser inscribing positive change in refractive index is particular to certain amorphous glasses. Accordingly, this technique while effective at creating waveguides in glass has not been seen as being a useful tool in creating waveguides in crystals or to improving laser cavities. In particular the change in refractive index is thought to be due to rearrangement of the molecular structure of that portion of the glass. The strong lattice structure of crystals suggests this would be difficult if not impossible to accomplish in crystals and if a change is effected this may damage the crystal structure so as not to be suitable for optics.

It is an object of the present invention to improve the existing methods of creating optical structures within crystals, providing different refractive indices within a crystal, and to provide crystal and laser crystals with more complex optical structures.

According to a first aspect of the invention there is provided a method of altering the refractive index of a portion of a crystal comprising focusing a pulsed laser beam at a desired position within the crystal and moving the focused beam along a path such that the focused beam alters the refractive index of the portion of the crystal along the path.

According to a second aspect of the invention there is provided a crystal comprising an inscribed structure wherein the structure has a different refractive index to the rest of the crystal.

According to a third aspect of the invention there is provided a method of producing a multi-core waveguide, comprising a plurality of coupled single waveguides, in a material, comprising the steps of, focusing a pulsed laser beam at a desired position within the material and moving the focused beam along a path such that the focussed beam alters the refractive index of the region of the material along the path, and refocusing a pulsed laser beam at a second desired position within the material and moving the focused beam along a second path separated from the first path such that the focused beam alters the refractive index of the region of the material along the second path.

Embodiments and methods of the invention will now be described, by way of example only, with reference to the accompanying drawings, in which:

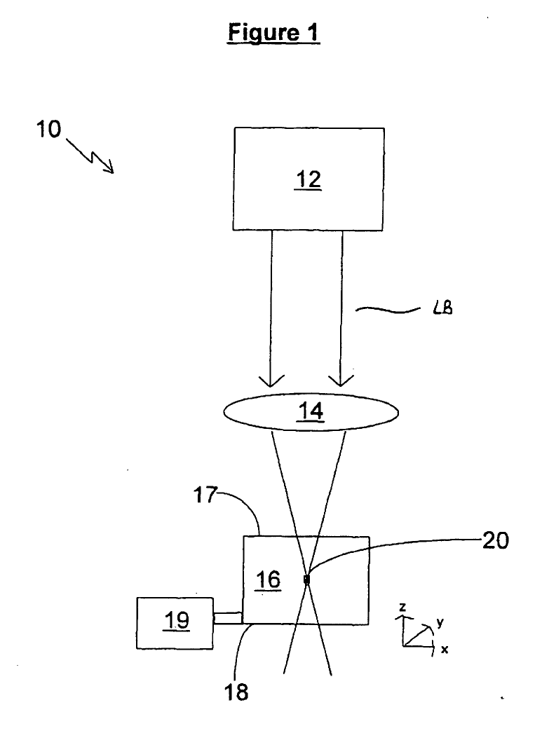

FIG. 1 is a schematic diagram of equipment which can be used in a method of performing the invention to inscribe Optical structures.

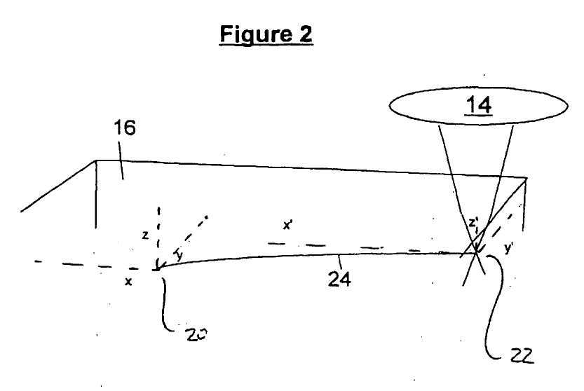

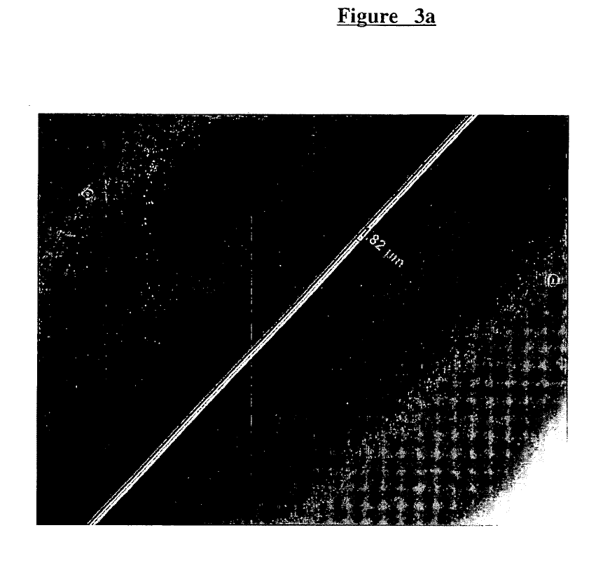

FIG. 2 is a view of an example of an inscribed predetermined path of a focused laser formed in accordance with the invention.

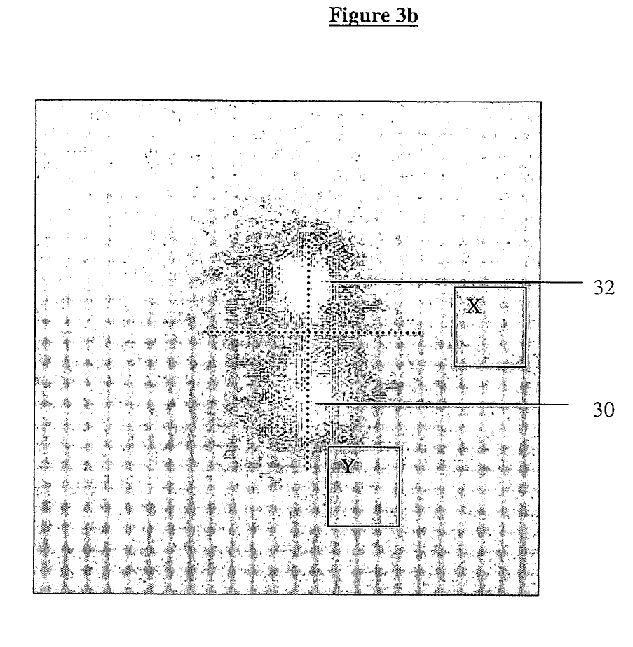

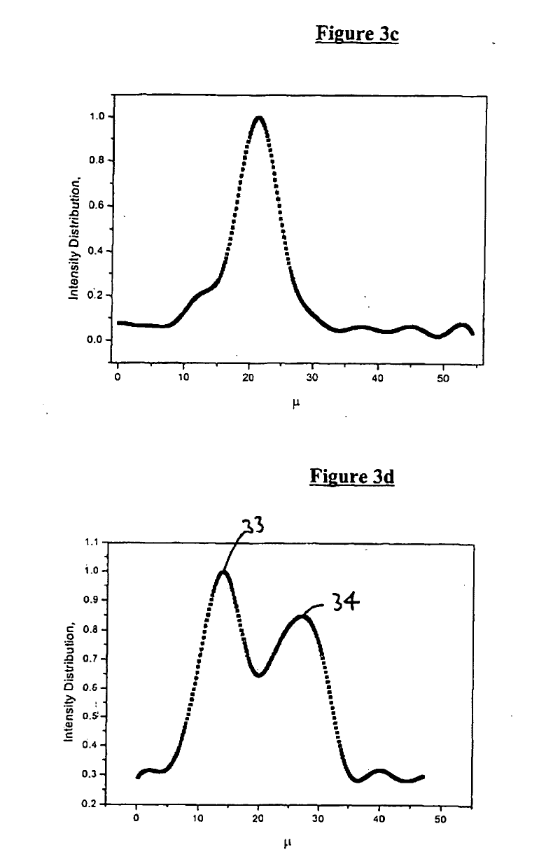

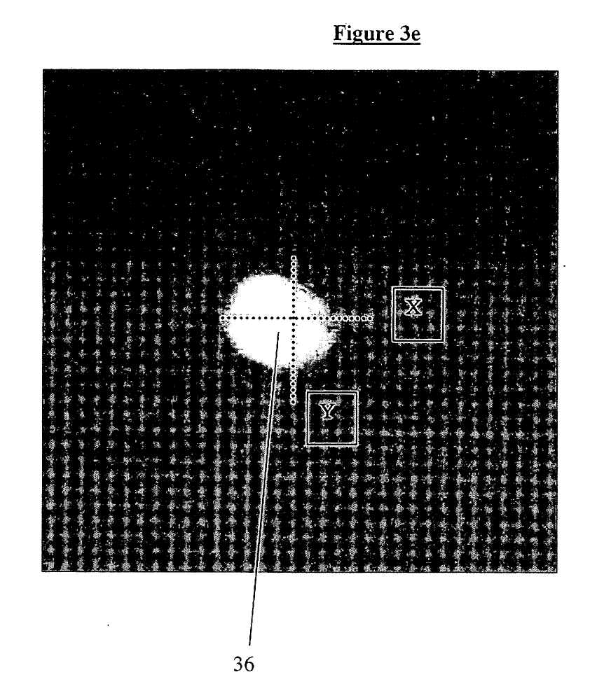

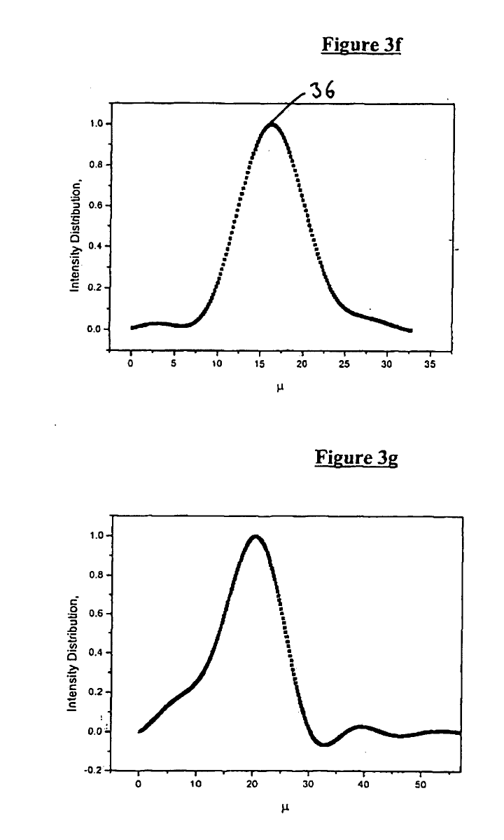

FIG. 3a is a microscopic view of an inscribed single waveguide.

FIG. 3b is a view of the near field profile of an inscribed waveguide.

FIG. 3c is a cross section of the near field measured in FIG. 3b in plane X.

FIG. 3d is a cross section of the near field measured in FIG. 3b in plane Y.

FIG. 3e is a view of the near field profile of a different inscribed waveguide.

FIG. 3f is a cross section of the near field measured in FIG. 3e in plane X.

FIG. 3g is a cross section of the near field measured in FIG. 3e in plane Y.

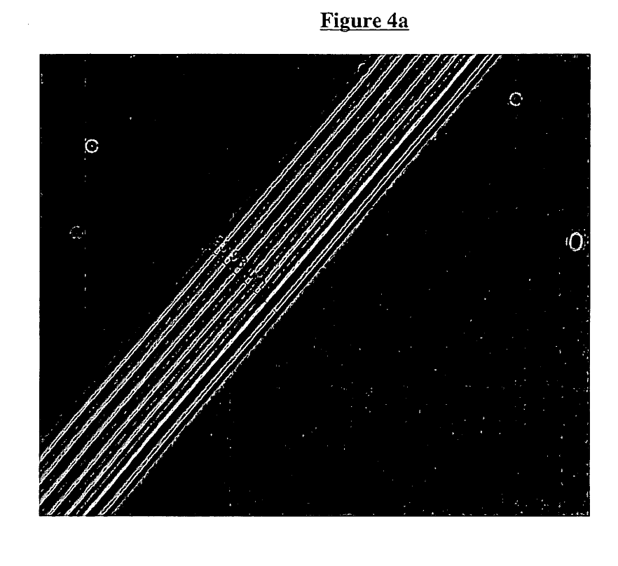

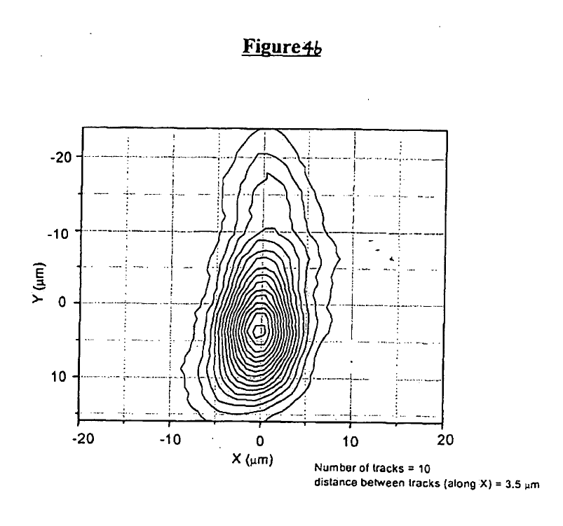

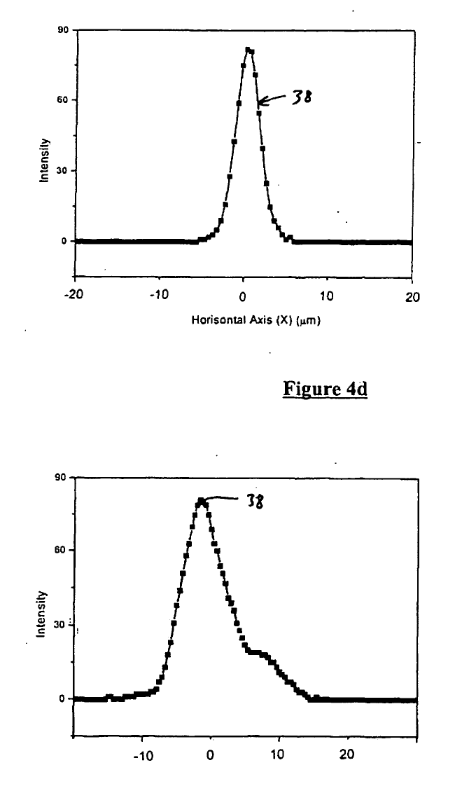

FIG. 4a is a top down view of an inscribed multicore waveguide.

FIG. 4b is a view of the near field profile of an inscribed multicore waveguide.

FIG. 4c is a cross section of the near field measured in FIG. 4b in plane X.

FIG. 4d is a cross section of the near field measured in FIG. 4b in plane Y.

FIG. 5a a schematic view of a crystal comprising an optical coupler according to the invention.

FIG. 5b a schematic view of a crystal comprising a Y coupler according to the invention.

FIG. 6 is a schematic view of a laser crystal comprising a diffraction grating according to the invention.

FIG. 7 is a schematic diagram of surface based and 3D gratings in a multicore waveguide.

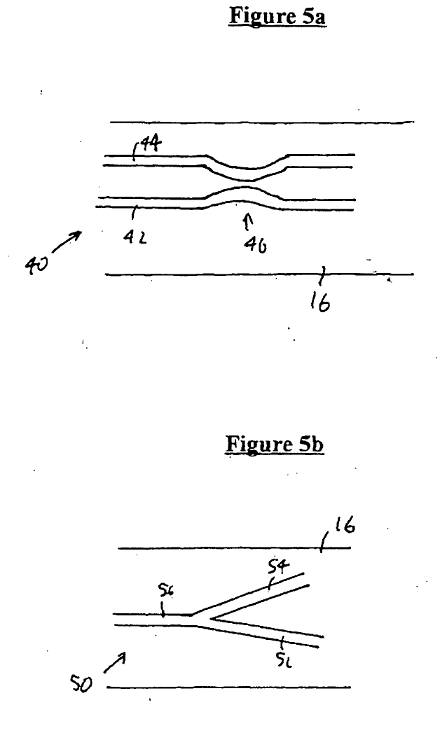

FIG. 8a is a view of a depressed cladding waveguide inscribed in YAG:Nd³⁺, and FIG. 8b is a view of a depressed cladding waveguide with a smaller cross-section also inscribed in YAG:Nd³⁺.

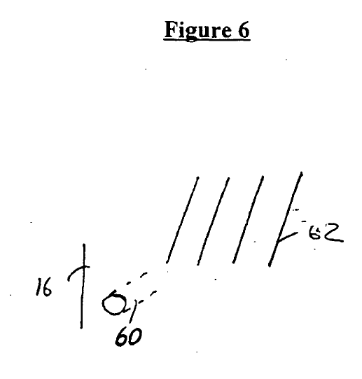

FIG. 9 is a schematic view of an experimental setup for creating the waveguide shown in FIG. 8.

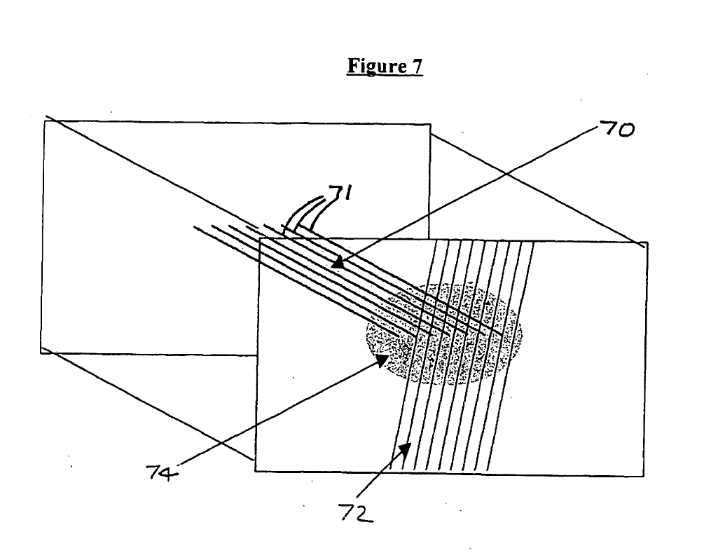

FIG. 10 shows the dependence of power output to pump power.

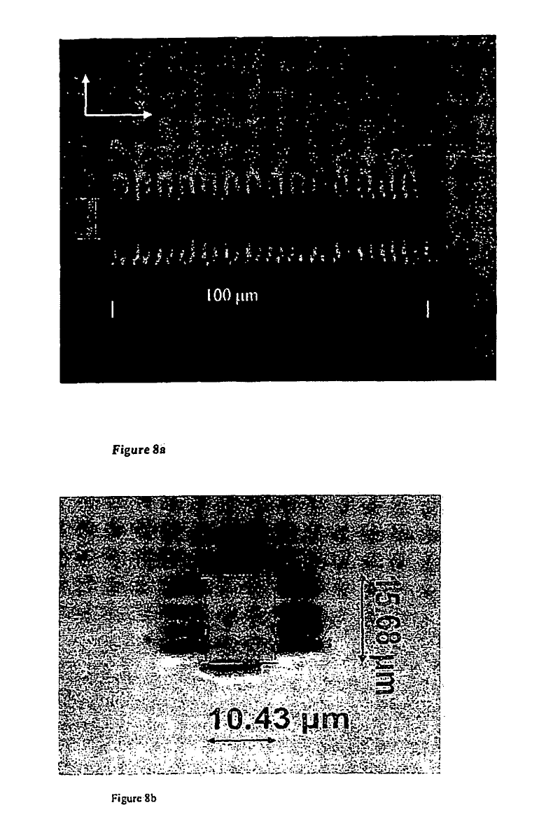

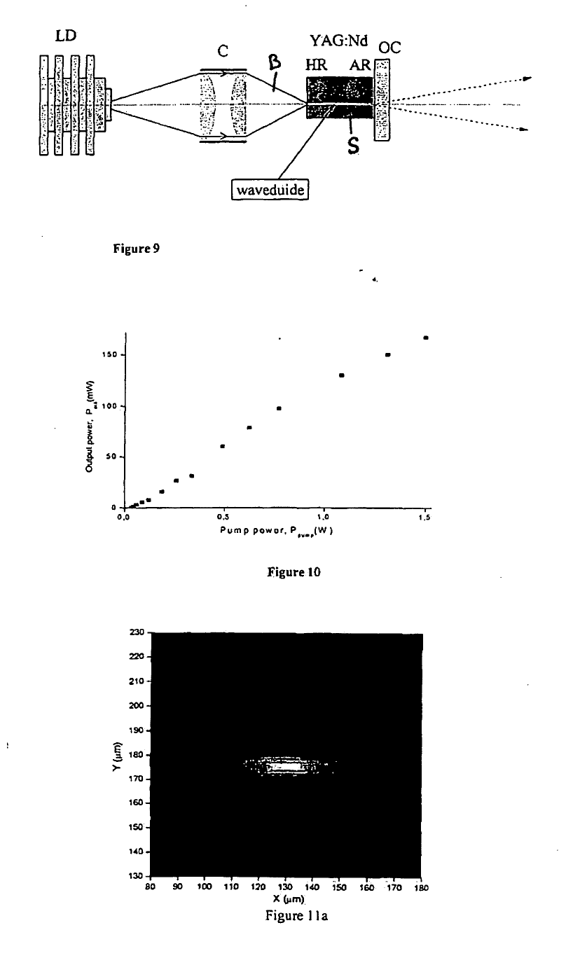

FIG. 11 provides near and far field images of the laser beam.

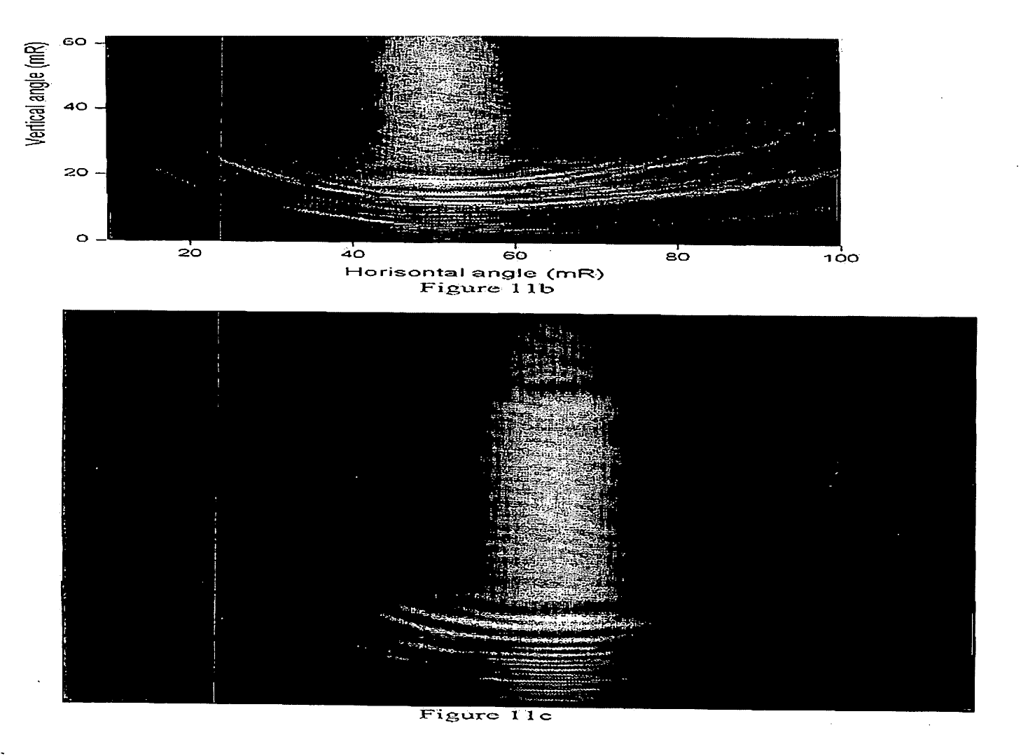

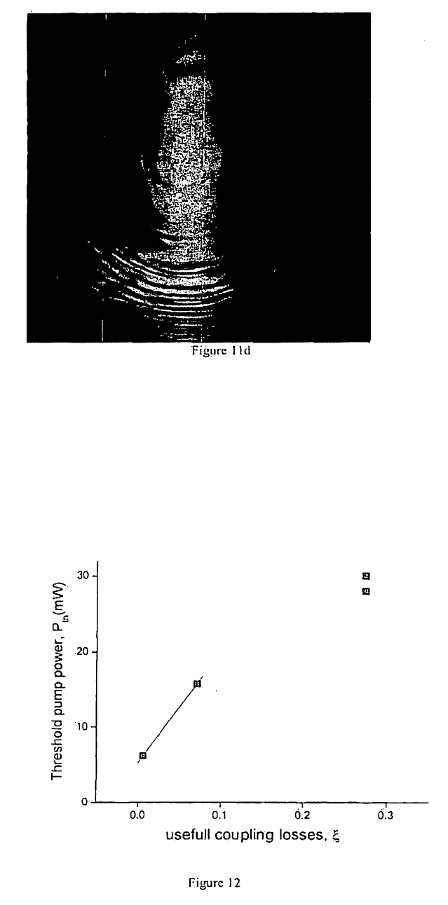

FIG. 12 shows a graph of the dependence of the threshold pump power on logarithmetic coupling losses.

FIG. 13 provides microscope photographs and refractive index profiles of single tracks.

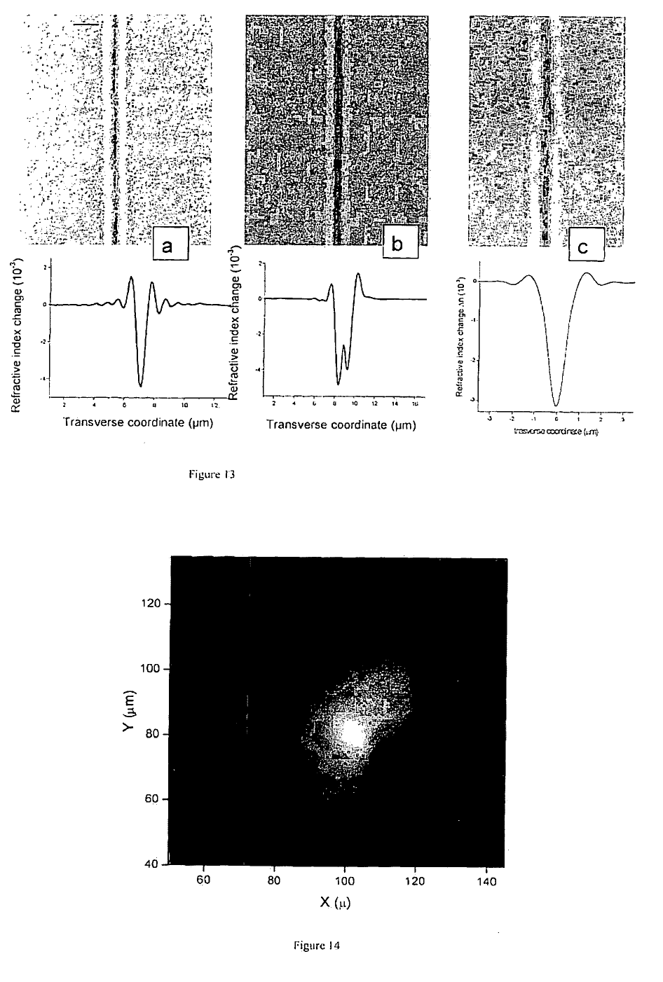

FIG. 14 provides a near field image of an output laser beam coupled with a waveguide.

In FIG. 1 is shown a schematic arrangement of equipment 10 suitable for practising the invention. The equipment 10 comprises a laser 12, a lens 14, a crystal 16 and translation device 19. A pulsed laser beam LB is generated by the laser 12.

The pulse laser beam LB is focused by lens 14 to a focus 20 situated in the crystal 16. As depicted in FIG. 1 the focus 20 is below a front surface 17 of the crystal nearest the laser 12 and above a rear surface 18 of the crystal furthest from the laser 12.

The intensity of the beam LB at focus 20 is far greater than at any other point along its length. Consequently, localised alteration of the refractive index of the crystal 16 is caused by the high intensity of the laser beam LB at focus 20.

The translation device 19, which can be for example a three coordinate micrometric translation stage, is used to move the crystal 16 three dimensionally in any of the X, Y or Z directions as shown in FIG. 1. Using this movement the focus 20 of the laser beam LB can be moved relative to the crystal 16 along a predetermined path. FIG. 2 shows an example of such a predetermined path 24 which extends from an initial focus 20 at coordinates XYZ to a finishing focus 22 at coordinates X′Y′Z′.

Coinciding with the path along which the focus 20/22 has been moved, there is created a region 24 along path 24 of altered refractive index. Since the region 24 has a different refractive index from the remainder of the crystal 16, the region forms an optical structure that can be used to guide light. In the example in FIG. 2 the optical structure formed extends in three dimensions between the starting and ending points 20 and 22, in the crystal 16.

In one particular example of the invention, the laser 12 can be a regenerated femtosecond amplifier (such as a Spitfire laser available from Spectra-Physics, Inc) operated at a wavelength of 800 nm with a pulse duration of 120 fs, a pulse frequency of 1 kilohertz and a pulse energy of 0.5 Mj.

Such a specification of laser 12 can be effectively used on a chromium doped YAG crystal including YAG: Cr⁴⁺ (Y₃Al₅O₁₂) and Cr³⁺ (Y₃Al₅O₁₂). It can also be used on Titanium or Cr³⁺ doped Sapphire Ti:Al₂O₃ , Chromium doped Forsteryte (Cr³⁺:Mg₂SiO₄, Cr⁴⁺:Mg₂SiO₄), Neodymium doped Vanadate (Nd³⁺:YVO₄), Cr³⁺ and Nd³⁺ doped GSGG, Cr³⁺ doped Li (Ca/Sr) AlF₆ and Neodymium, Yb³⁺, Er³⁺, Tm or Al³⁺ doped YAG.

A chromium doped YAG crystal 16 should also have additional co-dopants introduced in order to stabilise the active Cr⁴⁺ ions such as with Mg²⁺ or Ca²⁺ possibly with residual Cr³⁺. Co-dopants, such as Mg²⁺ ions, can also be used to stabilise active Cr³⁺ ions in YAG. The additional doping facilitates formation of point defects, and in particular oxygen vacancies in the lattice, within the crystal 16. The processes associated with the high density exposure to a femtosecond beam caused by the invention probably significantly changes concentration of these defects thus making YAG Cr⁴⁺ with additional dopants particularly well suited to inscription according to the invention.

It is thought that laser inscription of waveguides using the methods described would probably not be possible in a theoretical perfect crystal. It is thought that point defects such as the oxygen deficient defects in Chromium doped YAG facilitate the structural change under laser irradiation which allows waveguides to form such as by molecular rearrangement. Consequently laser crystals for inscription should contain point defects/dislocations and therefore the invention is best suited to doped crystals with corresponding defects/dislocations. The laser crystal to be inscribed preferably contains vacancies in the lattice allowing easier structural change around these vacancies.

Preferably when the invention is carried out with the combination of particular laser 12 and YAG crystal 16 described above, the lens 14 is a microscope objective with a numerical aperture in the range 0.2 to 0.65. With these particular laser 12, lens 14 and crystal 16 an example of the focus of the crystal 16 is about 0.3 to 4 millimetres and the estimated spot diameter at the focus is from 1 micrometer to about 10 micrometers.

In general the laser wavelength and crystal 16 are selected to minimise optical linear absorption of the laser beam LB by the crystal 16. Accordingly, the wavelength of the laser for YAG is in the range of about 1.35 to 1.57 lm in the near infra red range. Within these wavelengths absorption the beam by the crystal 16 is very low. The specific range of wavelengths in which suitable inscription of the crystal will occur is dependent on the extent of doping and on the specific material.

Time duration of each pulse is around 120 fs and typically in the range 100 to 200 fs which is significantly less than thermal diffusion time of the crystal 16 and the frequency of the pulses is around 1 kHz. The invention can also be realised with a pulse duration in the range 30-300 fs and a repetition rate in range from 0 to at least 1 MHz.

The period of pulses of the laser 12 is preferably selected to be significantly greater than the thermal diffusion time of the crystal 16. This allows each pulse to heat the material independently of the other pulses and helps to avoid the intensity or temperature on any part of the crystal 16 becoming too high, thereby preventing matter interaction of the dense plasma of free electrons from occurring outside of the locality of the focus 20. The intensity of the laser 12 is preferably chosen to be greater than the threshold to form free electron plasma but less than the laser breakdown or damage intensity of the crystal 16. The intensity of the laser at the surface of the crystal should also be preferably kept below the surface damage threshold.

The exact intensity of the laser used is dependent on how tightly focused the laser beam LB is at the focus 20. The more focused the laser the lower the energy need be. For example the diameter of the laser beam LB at the focus is preferably between 1 and 10 to 30 lm but could be up to 100 lm and still effect change of the refractive index. Translation of the device 19 is preferably done at a speed to prevent the same region or localities receiving excessive numbers of pulses.

In an alternative method instead of the crystal 16 being translated, the laser 12 can be translated using a device similar to translation device 19. Whether the refractive index of a region 24 produced using the method described above causes an increase or decrease in the refractive index relative to the remainder of the crystal 16 depends on the crystal material used. The amount by which the refractive index is changed depends on the particular crystal material but also on the intensity of the laser beam LB. After a region 24 has been produced as described above in a crystal 16 by laser 12 it is possible to measure the magnitude of the change of refractive index.

A positive change in the refractive index is achieved in Chromium doped YAG, Titanium doped Sapphire and suitable laser crystals. Materials in which a positive change in refractive index occurs are much more suitable for the creation of waveguides and other more complex optical structures since the region that has been altered will act as a waveguide.

The change in refractive index of the particular crystal 16 can be determined as a function of the laser beam intensity, and once this is done the optical structures can be created using regions 24 in the crystal 16 with the refractive indices altered by a predetermined/precalculated amount. The refractive index can also be varied along the region 24 by modulating the intensity of the laser 12 during translation of the focus 20 through the crystal 16.

Where the refractive index has been increased in the material, any altered region 24 of longitudinal extent becomes an effective waveguide surrounded by material of low refractive index i.e. the remainder of the crystal 16. In a crystal material where the refractive index is decreased by the laser inscription, waveguides can be formed by bordering or surrounding unaltered regions of the crystal 16 with altered regions 24 and so creating a region surrounded by a lower refractive index.

The altered region 24 can be created remote form the surface of the crystal 16 at depths exceeding and indeed far exceeding 10 mm. The region 24 can be created at any depth below the crystal surface providing optical equipment such as lens 14 is provided which is capable of focusing the laser beam LB at the required depth within the crystal 16.

In FIG. 3a is shown a microscope view of a single waveguide inscribed by the process described above in YAG:Cr(0.05%)Mg(0.25%).

In FIGS. 3b and 3e is shown the near field profiles of two separate single waveguides produced in YAG:Cr(0.05%)Mg(0.25%), which were inscribed under different conditions. The waveguide shown in FIG. 3b was produced with an average laser power of 13.7 mW and a sample translation speed 0.5 mm/s whereas the waveguide shown in FIG. 3b was produced with an average laser power of 10.1 mW and a sample translation speed 0.05 mm/s. The scale of FIGS. 3b and 3e is 100 lm across the horizontal and 60 lm in the vertical and the wavelength of light is 632 nm.

The waveguide shown in FIG. 3b can be seen as having multimode profile with two distinct similarly sized modes 30 and 32 shown in the near field profile. FIGS. 3c and 3d shows cross sections of the near field profile of FIG. 3b. In FIG. 3d two distinct peaks 33 and 34 can be seen representing the modes 30 and 32.

The near field profile in FIGS. 3e, f and g though shows that the waveguide made in the same material but with a different power and sample speed has a profile similar to a single mode being dominated by a single large mode 36.

The laser inscription can also be used to make a multicore waveguide comprising a number of coupled waveguides and a microscopic view of an example is shown in FIGS. 4a and 4b. Structures with 30 or more waveguides can be produced. Such structures with several coupled waveguides can be used to operate as a carrier of one or more common supermodes when the waveguides are phase dependent (that is when the phase of the field of each separate waveguide is dependent upon others).

A larger mode, such as the supermode that can be used with multicore waveguides, has several advantages particularly for use in a laser crystal. Large mode sizes allow efficient pumping by a multimode fibre, so that a laser crystal with a large mode allows the use of high-power laser diode pumps. A large mode size is advantageous for short-pulse operation as it minimises effects of non-linear processes. It also allows for reduced saturation of the laser medium which can be an advantage in certain configurations of laser.

In FIGS. 4b, c and d is shown the near field profile of a multicore waveguide. The multicore waveguide has ten waveguide tracks separated by 3.5 lm. As is shown the profile represents a single super mode 38 despite the presence of multiple tracks or cores. It has also been found that such multicore waveguides can have reduced losses associated with micro-bending and/or edge effects compared to single waveguides.

Single waveguides produced by inscription either in accordance with this invention or in glass may a strongly elliptical cross section as a result of the particular focusing conditions and exposure regime. In the same conditions, several suitably placed single cores with elliptical or other elongate cross sections can be combined to form a multicore waveguide supporting a quasi-circular supermode.

Multicore waveguides can be produced in suitable crystals using laser inscription with a mode size in the range of 30-100 lm and above with either elliptical a near circular shape.

To produce a multicore waveguide first a single waveguide region is produced using the method described with reference to FIGS. 1 and 2 creating a waveguide region along a first dimension. The focus of the laser is then moved away from the first waveguide region its position being precisely controlled through another dimension (preferably substantially perpendicular to the first). This movement of the “focus” is preferably done so that the region along the second dimension along which it has moved is not altered in refractive index; this can be done by temporarily lowering the power of the laser, translating the beam and crystal relative to each other at sufficient speed so that alteration of the crystal does not occur or by turning off the laser during the movement so that it is not a focus of the laser that is moved but the theoretical position where it is calculated that the focus would occur if the laser was on.

When the focus/position of potential focus is the required distance from the first altered region the operation is repeated with a second waveguide region of altered, preferably increased, refractive index being created using the method described with reference to FIGS. 1 and 2. Preferably the focus is not translated through the second (preferably perpendicular) direction during creation of the second region and consequently the two regions will be a constant distance apart throughout their lengths. In particularly preferred embodiments the two regions have equivalent paths i.e. if the first region starts at coordinates x, y, z and the second at x+1, y+1, z then the end points is x′, y′, z′ and x′+1, y′+1 and z′ respectively. In the example shown in FIGS. 4a and 4b the waveguide paths are substantially straight and parallel with all of the waveguide paths lying in the same plane.

This process can then be continued with the focus being shifted repeatedly along the second dimension with several waveguide regions being created.

It has been found that this method of creating multicore waveguides can also be used effectively in glasses.

As well as two and three dimensional waveguides other and more complex optical structures can be formed in a crystal 16 using the invention. Examples of more complex optical structures that can be formed are optical couplers shown in FIG. 9, diffraction gratings shown in FIG. 10, selective reflectors, loop mirrors, amplifiers and complex shaped regions such as helical regions.

In FIG. 5A is shown an optical coupler 40, comprising two waveguiding regions 42 and 44 formed using the method of the invention. In a central portion 46 the waveguiding regions are close enough for coupling to occur. A star coupler comprising more waveguiding regions can be made in a similar manner.

In FIG. 5B is shown a Y-coupler 50 comprising branch regions 52 and 54 and a main region 56. All of the regions 52, 54 and 56 are formed using the method of the invention using laser inscription and in this example formed in a laser crystal 16 in which the regions have an increased refractive index.

In FIG. 6 a waveguide region 60 leads to laser inscribed lines 62. It is possible to use the laser source 12 to provide sufficiently small spaces between the lines 62 so that the lines act as grating lines for the tunnelled optical structure 64 and therefore to act as a diffraction grating. Such lines 62 can be produced as either surface based grating or a Bragg grating distributed along the waveguide. When used with single mode structures gratings can be used to provide very precise spectral control and/or pump to signal discrimination.

In FIG. 7 is shown a grating structure produced for a multicore waveguide. A multicore waveguide region 70, comprising a plurality of parallel core regions 71, leads to periodic surface structure 72. The structure 72 may for example consist of laser inscribed lines similar to lines 62 to act as a diffraction grating. As is shown in FIG. 7 the supermode 74 of the waveguide 70 can extend across the whole of the periodic surface structure 72. Three dimensional gratings together with Fresnel lens like surface relief elements can be used with the multicore waveguide 70 to provide spatial mode control and partial spectral control.

Waveguides and other optical structures such as selective reflectors can be formed by refractive index change of regions of a laser crystal in a predetermined manner using the methods described above. Such an inscribed laser crystal can be used as a component for building a highly effective compact laser cavity. It is possible to create an entire simple laser cavity within a suitable crystal. Crystals such as YAG's and Ti:Al₂O₃ can have such optical structures produced in them in order to produce a laser crystal with a higher optical gain.

Indeed, there is now described a technique of direct writing of depressed cladding waveguides by a tightly focused, femtosecond laser beam in laser crystals which has been developed. A laser based on a depressed cladding waveguide in a Neodymium doped YAG crystal, is now described in relation to FIGS. 8 to 12.

As already discussed, femtosecond laser inscription in dielectric materials is an emerging and promising technology which has already proved to be a powerful and flexible tool for optoelectronic components manufacture. Waveguiding structures in some materials, including many types of glass, can be written directly, as the laser exposure produces positive change in refractive index. In crystal materials, the change of refractive index can be either negative or positive. Therefore, direct writing of waveguides in crystals is not always possible. At the same time, it would be highly advantageous to adapt the femtosecond inscription approach for making waveguides in crystal media. In particular, laser crystals, such as YAG, represent an interesting target in the view of potential applications for development of waveguide lasers. We have found that the refractive index change is predominantly negative in YAG:Nd crystals, making it possible to form the waveguides by defining a depressed-index cladding.

In this example, femtosecond inscription of depressed cladding waveguides in a family of laser crystals of great practical importance—YAG crystals is discussed. The core consists of an unexposed area whilst the cladding is formed by a number of separate parallel tracks. In this manner the first laser based on a laser-inscribed waveguide in a YAG: Nd crystal is described as shown in FIG. 8.

The experimental technique involves the use of an amplified laser system, operating at a wavelength of 800nm, producing 150fs-long pulses at a repetition rate of 1 kHz. Laser beam B (shown in FIG. 9) was focused at a depth of 200 mm under a polished surface (HR) of the samples using a ×40 microscope objective with the numerical aperture of 0.65. Patterning was provided by translation of the sample mounted on a high-precision translation stage. The energy of the pulse arriving at the sample was varied and always kept below the optical damage threshold. Above a certain ‘inscription threshold’, permanent change of refractive index was observed. After the inscription, the surfaces of the crystal at the ends of the tracks were re-polished.

Single tracks have thus been inscribed in YAG crystals which exhibit waveguiding properties. A further investigation revealed that the femto-inscribed features in YAG crystals possess complex geometry and include volumes of material with increased and volumes of material with decreased refractive index. The exact refractive index profile is subject to the focusing geometry and the exposure level. In this study, it was found that in all types of YAG crystals, the refractive index change is negative in the central area of the inscribed “feature” whether it is a single spot or a track. By writing the tracks around the unmodified central volume of material, a depressed cladding can be produced with the central volume serving as the core of a waveguide. The structure is therefore similar to certain types of microstructured optical fibres. In this study a waveguide was written in a crystal of YAG:Nd³⁺ with the Neodymium concentration of 1 mol. %.

The technique has proven to be flexible enough for definition of arbitrarily shaped waveguides. For this study, a rectangular shape waveguide was produced with the core size 100 lm by 13 lm along X and Y axes accordingly (FIG. 8). This particular geometry was chosen in order to approximately match the mode profile of the waveguide with that of a typical pumping laser diode, operating at 809 nm wavelength. One can see that the tracks possess some internal structure (FIG. 8). However, the change of refractive index, averaged across the cross-section of each track, is always negative, which was established by phase delay measurements.

The crystal was 10 mm long, which is of course excessive for 1% of Nd concentration. Such high length was chosen for reliable inhibition of bulk modes and thus to clearly demonstrate waveguiding character of lasing. The waveguide ends were covered with the dielectric coatings which were highly-reflective (HR) on one side and anti-reflective (AR) on the other side at a wavelength of 1064 nm. The HR coating transmitted 90% of pumping emission at wavelength of 809 nm (FIG. 9).

The waveguide was pumped through the HR coating facet by a beam from a high-power laser diode (LD). The size of the laser emitting area was 1×200 mm, and a standard cylindrical lens was permanently attached to the LD output. A collimator C was used with the magnification of 0.5 in order to couple the laser diode beam into the waveguide. The overall coupling efficiency was about 65%. A flat mirror was attached directly to the AR side of the waveguide, serving as an output coupler (OC in FIG. 9).

Alignment of the waveguide and propagation of the pumping beam were monitored under a microscope. The up-conversion emission, produced by the pump, made the waveguide clearly visible and thus helped to optimise the alignment. Laser oscillation was observed at the wavelength 1064 mm, which was checked on 1 m grating monochromator with InGaAsP photodiode.

Dependence of the laser output on pumping power is shown in FIG. 10 for transmittance of output coupler T_{OC}=24%. The lasing threshold was 30 mW in this configuration, and the power conversion efficiency was 11%. It should be noted, that concentration of Nd³⁺ ions was not optimal for oscillation with such high pump intensity as in our experiment. Up-conversion strongly depopulates upper laser level and reduces quantum efficiency. We consider that the crystal with lower concentration of the activator has to be used to increase quantum efficiency.

The field profiles of the laser output were measured by means of a CCD camera. The near field image was formed at the camera input by an objective producing magnification of a factor of 12. The far field images were obtained by placing the camera directly in the laser beam at a distance of 6 cm, exceeding the Raleigh distance. Beam images and field profiles, measured at a moderate pump power level of 0.27 W and transmittance of OCT_{OC}=6.9%, are shown in FIG. 11. The near field profiles are well approximated by Gaussian functions (shown in FIG. 11a as dashed lines), with the half widths measured at e⁻² intensity level of rₒₓ=36 mm and r_{oy}=6.6 mm along X and Y axes correspondingly. Thus, the laser mode is well confined in the waveguide core. The far field profiles are also well approximated by Gaussian ones with divergence half-angles of 9.4 mR and 51 mR for X and Y axes respectively. These values are very close to the transform-limited ones of 9.6 mR and 47 mR, calculated from the Gaussian approximations of the near-field value, indicating that the waveguide laser oscillates predominantly in the fundamental mode.

An additional beam can be seen in the far-field profiles which appears as a circular pattern diffracting in the transverse plane (FIG. 11). The centre of symmetry of the pattern coincides with that of the laser mode, but the intensity is not uniformly distributed around the circle. A possible reason for this pattern is the diffraction of the fundamental mode on the complex periodic structure of the cladding.

Referring to FIG. 11, there is shown four images of a laser beam measured with different levels of output coupler transmission. In FIGS. 11a and 11b, the new field and far field (respectively) images of a laser beam are measured with output coupler transmission of T_{OC}=6.9% at a level of pumping of Pₚᵤₘₚ=0.27 W. In FIGS. 11c and 11d, there is shown a far field image of laser beam measured with output coupler transmission of 24% at a level of pumping power just above the lasing threshold (FIG. 11c) and at a level of pumping power of 1.5 W (FIG. 11d).

By pumping a volume of the crystal beam away from the waveguide, it was possible to obtain lasing with several mW of output power in the bulk modes. However, the lasing threshold in that case was as high as 1 W, compared to 30 mW in the waveguide mode for 24% transmittance of OC. Therefore, the waveguide laser showed a performance considerably superior to that of the bulk laser in the same crystal. Such behavior is quite expected, because an angle between coated facets of crystal was equaled to 2.5 mRad, which induce very high diffraction losses for a bulk mode. Apparently, only due to thermal lens induced by pump beam at pump power exceeding 1 W a volume mode reaches threshold.

No degradation of the output power or a beam shape was observed after several tens of hours of laser operation.

Given the good accuracy of the Gaussian approximation for description of the fundamental mode profiles, one can estimate the waveguide

At last, in order to estimate losses in the waveguide following Findlay-Clay analysis the laser performance was compared with three different output couplers. At this stage additionally to dependence shown in FIG. 10, the laser output was measured as a function of pumping power using two other couplers with transmission coefficients of 0.62 % and 6.9 %. FIG. 12 shows a dependence of threshold power Pₜₕ on the useful logarithmic coupling losses, defined as x=−In(1−T_{OC}). This dependence should be linear, if other laser parameters, except T_{OC} are unchanged:
Pₜₕ(ξ)=K(ξ+L) (3),
where K is the unchanged coefficient including efficiency of pumping, and L is the intrinsic round-trip logarithmic losses in the resonator. But experimental points obtained obviously do not lie on a straight line. The discrepancy with classical dependence could be explained by a thermal lens induced effect, which facilitated coupling of the pump beam, and consequently decreased the threshold pump power. From this view theoretical dependence describes better two experimental point for lowest threshold power, and intersection of a strait line drown through its with the X axis gives an estimate of intrinsic losses in the resonator. The estimate gives a value for the intrinsic round-trip propagation loss of 3.6%. Neglecting the parasitic losses at the waveguide ends, this corresponds to the normalised loss 0.018 cm⁻¹ in the waveguide. index step. Firstly, for as much as “X” size of the waveguide is rather larger, than “Y” size, we assume a planar model. Then, we consider the rectangular profiles of refractive index change along Y axis. This is in line with the above observation of good confinement of the mode within the waveguide, and a relatively large cladding size for Y coordinate. We also note that the laser oscillated in a fundamental mode. This of course does not prove that the waveguide generally supports one mode only. However, from these measurements we can estimate the lowest possible value of the waveguide parameter V_{y} for Y coordinate, and, hence, the minimum value of the effective step of refractive index. Firstly, the waveguide parameter can be obtained as:

$${V}_{y} = \sqrt{\frac{\sqrt{π} {ρ}_{y}}{2 {r}_{0 y}}} exp ( \frac{{ρ}_{y}^{2}}{2 {r}_{0 y}^{2}} ) , \qquad ( 1 )$$

where V_{y} is the waveguide half thickness (r_{y}=6.5 mm ?in our case) and r_{0y} is half of the fundamental mode size along Y coordinate (r_{0y}=6.6 mm). Equation (1) yields V_{y}=1.52. Substituting this value in the definition formula for V-parameter:

$${V}_{v} = \frac{2 π {ρ}_{v}}{λ} \sqrt{2 n Δ n} , \qquad ( 2 )$$

one obtains an estimate for the lowest possible value of effective refractive index step for upper and low bar of cladding as Dn_{y}³4·10⁻⁴ (see FIG. 11). loss of 3.6%. Neglecting the parasitic losses at the waveguide ends, this corresponds to the normalised loss 0.018 cm⁻¹ in the waveguide.

Tracks of permanently changed refractive index have been produced in YAG crystals by femtosecond inscription and arranged to form depressed-cladding waveguides of a predetermined shape. A low-threshold laser based on such waveguide has been demonstrated for the first time. The waveguide losses were estimated to be as low as 0.02 cm⁻¹.

In our investigations it has been found that the femto-inscribed features in YAG crystals possess complex geometry and include volumes of material with increased and those with decreased refractive index. Typically, the refractive index change is negative in the central area of an inscribed “feature” whether it is a single point or a track, and is positive at the edges of the processed volumes (FIG. 13). Thus a waveguide is formed in close vicinity of an inscribed track. FIG. 14 demonstrates such behaviour. At the near field image of a laser beam passed through the waveguide obtained a dark elliptical spot originated from an inscribed track is clearly observed near the beam. The exact refractive index profile depends on the focusing geometry and on the exposure level.

The effect of femtosecond inscription in YAG:Cr⁴⁺, YAG:Nd³⁺ and undoped YAG has been compared. The experimental setup was similar to that already described and included an amplified, femtosecond Ti:sapphire system, variable attenuator, X63 or X40 microscope objective and a high-precision, computerised translation stage. The tracks were produced by translating the stage with a mounted sample across the laser beam at a constant speed.

By adjusting the exposure level, it was possible to produce tracks of modified refractive index in all samples. FIG. 13 shows the microscope views of the tracks and the corresponding refractive index profiles. As can be seen from FIG. 13, a reason of decreased refractive index is formed at the core, or centre, of the laser inscribed region. The core is then immediately defined within regions of increased and decreased refractive index. Overall, the effect of the laser inscription is to provide a region having an effective or average refractive index which is decreased compared to prior to inscription.

Long-lasting modification of refractive index occurs at the exposure levels below the damage threshold. In our case, it is possible to define the “inscription threshold” below which no permanent changes happen in the material. In the experiment, we estimated the inscription threshold to be approximately (1-2)×10¹⁴ W/cm² for YAG:Cr⁴⁺ and YAG:Nd³⁺. The inscription threshold for undoped YAG is approximately by an order of magnitude greater. This difference may indicate that the crystal point defects define the possibility of “smooth” modification of crystal lattices of the YAG crystal, resulting in the well-defined refractive index change. The dopants present in a YAG crystal generate large number of defects and thus facilitate the modification of crystal lattice without optical damage.

The refractive index change in doped YAG crystals were compared at the intensity level of 1×10¹⁵ W/cm² . The value of the index change was found to correlate with the dopant concentration. In YAG:CR⁴⁺ with the doping level of 0.6% mol., the peak index change was 0.006. The same value was measured in YAG:Nd³⁺ with 1% mol. of dopant. The refractive index change in the YAG:CR⁴⁺ crystal with a lower dopant concentration of 0.3% mol. was 0.003. No changes of the index change was observed in the undoped YAG sample at these level of exposure. The track in the pure YAG sample, shown in FIG. 13c, was produced at the intensity level of 2×10¹⁵ W/cm² approximately, just above the inscription threshold.

At the next stage, several parallel single tracks were inscribed in a crystal in order to produce a depressed cladding waveguide. The technique immediately proved to be flexible enough for definition of arbitrarily shaped waveguides. FIG. 14 shows two examples of waveguides produced in YAG:Nd³⁺, one—with the waveguide size of 16×10 lm and another—100×10 lm. The waveguide with the high aspect ratio was produced as an example of structure, potentially well suited for a waveguide laser with efficient pumping by a high-power laser diode.

The stability of long-lasting refractive index changes in YAG:CR⁴⁺ was tested by heat treatment at a temperature of 1250C during 72 hours in air, which matches the fabrication conditions of YAG:Cr⁴⁺ at the stage when the 4-fold coordinated Cr⁴⁺ ions are generated. Microscope inspection has shown no changes in the inscribed tracks, thus indicating the permanent nature of the inscribed features.

Tracks of long-lasting change of refractive index have been produced in YAG crystals by femtosecond inscription. It has been shown that arbitrarily shaped, depressed-cladding waveguides can be formed by groups of tracks arranged in a predetermined pattern.

1. A method of altering the refractive index of a region of a crystal comprising focusing a pulsed laser beam at a desired position within the crystal and moving the focused beam along a path such that the focused beam alters the refractive index of the region of the crystal along the path.

2. A method according to claim 1 in which the refractive index of the region is increased.

3. A method according to claim 1 or 2 in which the altered region of the crystal comprises a waveguide.

4. A method according to claim 1, 2 or 3 comprising the steps of moving the focused beam along multiple paths to create a diffraction grating within the crystal.

5. A method according to claim 1, 2 or 3 comprising the steps of moving the focused beam to create a selective reflector within the crystal.

6. A method according to any preceding claim in which at least part of the region of altered refractive index is created remote from the surfaces of the crystal, preferably at a distance of more than 10 lm.

7. A method according to claim 6 wherein the region is created at variable depth from the surfaces of the crystal and preferably forms a three dimensional light guiding structure within the crystal.

8. A method according to any preceding claim in which the effective refractive index of the region is altered by a predetermined amount and preferably increased with respect to the effective refractive index of the adjacent material.

9. A method according to claim 8 in which the intensity of the light beam is modulated whilst the focused beam is moved modulating the predetermined change to the refractive index which is proportional to the intensity.

10. A method according to any preceding claim in which no laser-induced breakdown of the crystal in the path has occurred.

11. A method according to any preceding claim wherein the crystal on which the laser is focused is a laser crystal suitable for use in producing a laser.

12. A method according to claim 11 in which the laser crystal is YAG, Forsteryte, Vanadate, LiSAF, GSGG or Sapphire .

13. A method according to claim 11 or 12 in which the laser crystal is doped, preferably with a metal.

14. A method according to claim 12 or 13 in which the laser crystal is chromium doped, Titanium doped, Tm, Er, Yb or neodymium doped.

15. A method according to claim 14 in which the laser crystal has additional co-doping.

16. A method according to any of claims 11 to 15 in which the laser crystal contains a number of point defects, preferably a substantial number and/or preferably vacancy defects.

17. A method according to any preceding claim in which multiple regions of altered refractive index are created at multiple different depths within the crystal.

18. A method according to any preceding claim wherein the light beam used is a pulsed laser.

19. A method according to claim 18 wherein the pulsed laser is a femtosecond laser with a pulse duration of below 200 fs and preferably around 120 fs.

20. A method according to claim 18 or 19 wherein the laser is operated at wavelength of between 1.35 lm and 1.57 lm, and preferably 1.5 lm, and/or at a wavelength chosen to minimise linear absorption by the crystal.

21. A method according to any of claims 18 to 20 wherein the laser has a pulse frequency of between 0.5 And 1.5 kHz and preferably around 1 kHz.

22. A method according to any of claims 18 to 21 wherein the laser has a pulse energy of around 0.5 mJ.

23. A method according to any preceding claim in which the beam is focused by a microscope objective preferably with a numerical aperture in the range 0.2 to 0.65.

24. A method according to any preceding claim in which the focused beam is moved periodically along the path.

25. A laser cavity at least part of which and preferably all is made by the method of any preceding claim.

26. A crystal comprising an inscribed optical structure wherein the structure has a different refractive index to the rest of the crystal and preferably a higher refractive index.

27. A laser crystal for producing a laser beam comprising the crystal of claim 26.

28. A laser cavity comprising the crystal of claim 26 or 27.

29. A crystal according to any of claims 26 to 27 in which the crystal is YAG, Forsteryte, Vanadate, LiSAF, GSGG or Sapphire.

30. A crystal according to any of claims 26 to 29 in which crystal is doped with a metal and preferably Chromium, Titanium, Tm, Er, Yb or Neodymium doped.

31. A crystal according to any of claims 26 to 30 in which the crystal has additional doping and preferably with Magnesium or Calcium.

32. A crystal according to any of claims 26 to 31 wherein at least part of the optical structure is remote from the surfaces of the crystal.

33. A crystal according to claim 32 wherein at least part of the optical structure is at a depth of over 10 ?m from the surface of the crystal and preferably over 100 lm.

34. A crystal according to any of claims 26 to 33 wherein the optical structure is surrounded on all sides by non-inscribed crystal of uniform refractive index and forming part of the same lattice.

35. A crystal according to any of claims 26 to 34 wherein the optical structure is three dimensional/has a variable depth with respect to surfaces of the crystal.

36. A crystal according to any of claims 26 to 35 wherein the optical structure comprises a waveguide.

37. A crystal according to claim 36 wherein the optical structure comprises a mulitcore waveguide having a plurality of coupled single waveguides.

38. A crystal according to claim 37 wherein the multicore waveguide is capable of operating as carrier of a common supermode.

39. A crystal according to claim 37 or 38 wherein the plurality of coupled single waveguides are each separated by less than 5 lm and preferably separated by around 3.5 lm.

40. A crystal according to any of claims 26 to 39 wherein the optical structure comprises a diffraction grating.

41. A crystal according to any of claims 26 to 40 wherein the optical structure comprises a selective reflector.

42. A crystal according to any of claims 26 to 41 wherein the optical structure comprises an optical coupler.

43. A crystal according to any of claims 26 to 42 wherein the optical structure has a lower refractive index than rest of crystal.

44. A crystal according to any of claims 26 to 43 wherein the material of the optical structure is part of the crystal and has not broken down.

45. A crystal according to any of claim 26 to 44 wherein the optical structures comprises a plurality of tunnel regions which passing above or on the side of each other inside the crystal.

46. A crystal according to any of claims 25 to 45 having an increased quantity of defects throughout the crystal.

47. A crystal according to claim 46 wherein the defects comprise one or more of point defect such as vacancies, interstitial defects and substitutional impurity defects.

48. Crystal according to claim 46 wherein the defects comprise dislocations.

49. Crystal according to claim 48 wherein concentration of point defects is in the range 10¹⁸-10²¹ cm⁻³.

50. Crystal according to claim 48 or 49 wherein concentration of dislocations is in the range 10⁷-10¹¹ cm⁻².

51. A method of producing a multicore waveguide, comprising a plurality of coupled single waveguides, in a material, comprising the steps of, focusing a pulsed laser beam at a desired position within the material and moving the focused beam along a path such that the focussed beam alters the refractive index of the region of the material along the path,
and refocusing a pulsed laser beam at a second desired position within the material and moving the focused beam along a second path separated from the first path such that the focussed beam alters the refractive index of the region of the material along the second path.

52. A method according to claim 51 in which the first and second paths are separated by a substantially constant distance.

53. A method according to claim 51 or 52 wherein the multicore waveguide is capable of operating as carrier of a common supermode.

54. A method according to claim 51, 52 or 53 wherein the plurality of coupled single waveguides are each separated by less than 5 lm and preferably separated by around 3.5 lm.

55. A method according to any of claims 51 to 54 wherein the step of refocusing and creating an additional altered region along an additional path is repeated 10 or preferably 20 times to produce a multicore waveguide comprising 10 or preferably 20 coupled single waveguides

56. A method according to any of claims 51 to 55 wherein the material comprises a crystal.

57. A method of fabricating an optical structure in an active crystal comprising focusing a pulsed laser beam at a desired position within the crystal and moving the focused beam along a path such that the focused beam alters the refractive index of the region of the crystal along the path.

58. A method according claim 1, 51 or 57 in which the average refractive index of the region is decreased.

59. A method according to claim 58 wherein the refractive index of the region is increased in part and decreased in other parts.

60. A laser formed by a waveguide inscribed in a crystal of YAG lodged with Nd³⁺.

61. A laser according to claim 60 and 36 or 37 and having feedback elements.

62. A laser formed by an effective waveguide having a cladding of depressed refraction index, preferably where the core of unmodified material is surrounded, at least in part, by a number of tracks comprising material modified in a way to mainly decrease the refractive index.
